(19) United States
(12) Patent Application Publication
(10) Pub. No.: US 2017/0284577 A1
(43) Pub. Date: Oct. 5, 2017

(54) Tamper Resistant Coupling Collar

(71) Applicant: Micro Matic USA, Inc., Brooksville, FL (US)

(72) Inventors: Michael Tomlinson, Spring Hill, FL (US); Richard Parks, Clyde Hill, WA (US)

(73) Assignee: Micro Matic USA, Inc., Brooksville, FL (US)

(21) Appl. No.: 15/090,651

(22) Filed: Apr. 5, 2016

(51) Int. Cl. F16L 23/036; F16L 13/10

(52) U.S. Cl. CPC F16L 23/036; F16L 13/10

(57) ABSTRACT

A tamper-resistant coupling collar is provided. The tamper-resistant coupling collar may be configured to couple an air pulse generating unit to the coupler of a container that contains a liquid to be mixed by introducing an air pulse from the air pulse generating unit. The collar may include a flange portion and body portion, and the flange portion may include a plurality of holes configured to receive fasteners to couple the collar to the air pulse generating unit.

### TECHNICAL FIELD

The present disclosure relates generally to a collar for coupling a hose to a container, and more specifically to a collar that is tamper-resistant or provides evidence of tampering if one attempts to remove the collar.

### SUMMARY

In the container industry, some containers are part of a “closed” system, in which the container is filled and emptied without exposing the contents of the container. For example, closed systems are commonly used in storing and transporting insecticides to reduce the risk of human interaction with harmful insecticides. From time to time it becomes necessary to stir the contents of these containers, but because it is a closed system, this must be accomplished without opening the container. One technique for stirring the contents is to inject pulses of air into the container, which is done by connecting a machine that generates the air pulses to the container using a coupler. The coupler is typically keyed to a valve in the container such that contents can only be extracted from or inserted to the container via the specifically-keyed coupler. By using such a coupler, unauthorized filling of the container can be prevented. However, if the coupler can be disconnected from the air pulse device, the coupler can be used for unauthorized filling of the container. Unauthorized filling presents numerous problems, including lack of quality control regarding the quality of the contents placed in the container. Unauthorized filling would also potentially allow one to fill a container with water or some or other liquid so that the container weighs as much as a full container of insecticide, and charge full price for a full container of insecticide. Accordingly, it is beneficial to prevent unauthorized filling or at least provide evidence that unauthorized filling has occurred so as to alert the owner of the container of a potential problem.

According to an aspect of one or more exemplary embodiments, there is provided a tamper-resistant or tamper-evident collar that is secured to the air pulse unit in such a way that removing the collar from the air pulse unit is impossible or at least leaves an indication that the collar was removed. The collar according to one or more exemplary embodiments may include a body portion having a first diameter and a flange portion having a second diameter that is greater than the first diameter. The flange portion may include a plurality of holes configured to receive fasteners that couple the collar to an air pulse generating unit.

The plurality of holes in the flange portion of the collar may be configured to break the fasteners if the collar is attempted to be disconnected from the air pulse generating unit.

The body portion may include a plurality of facets connect to each other around the circumference of the body portion.

The body portion may also include a threaded inner portion configured to securely receive a coupler device. The threaded inner portion may include a permanent adhesive configured to adhere the collar to the coupler device.

The flange portion may include a hole configured to receive a nipple portion of the air pulse generating unit. The hole in the flange portion may include a permanent adhesive configured to adhere the nipple portion of the air pulse generating unit to the flange portion of the collar.

### BRIEF DESCRIPTION OF DRAWINGS

FIG. 1A is a perspective view of a tamper-resistant or tamper-evident collar according to an exemplary embodiment.

FIG. 1B is a perspective view of a tamper-resistant or tamper-evident collar according to another exemplary embodiment.

FIG. 2 is a side view of a tamper-resistant or tamper-evident collar according to an exemplary embodiment connecting an air pulse unit to a coupler.

FIG. 3 is a cross-sectional view of a tamper-resistant or tamper-evident collar according to an exemplary embodiment.

FIG. 4 is a cross-section view of a tamper-resistant or tamper-evident collar according to another exemplary embodiment.

### DETAILED DESCRIPTION OF EXEMPLARY EMBODIMENTS

Reference will now be made in detail to the following exemplary embodiments, which are illustrated in the accompanying drawings, wherein like reference numerals refer to like elements throughout. The exemplary embodiments may be embodied in various forms without being limited to the exemplary embodiments set forth herein. Descriptions of well-known parts are omitted for clarity.

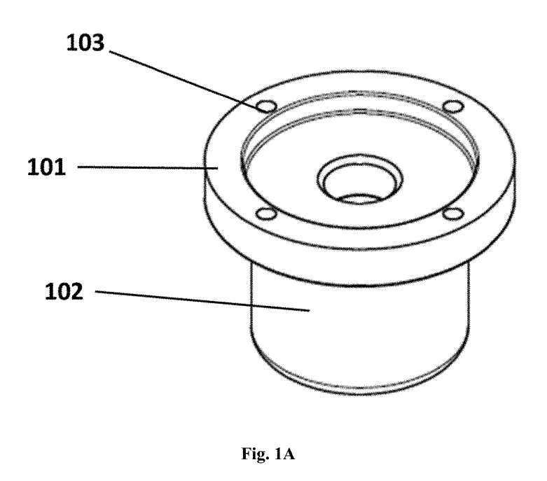

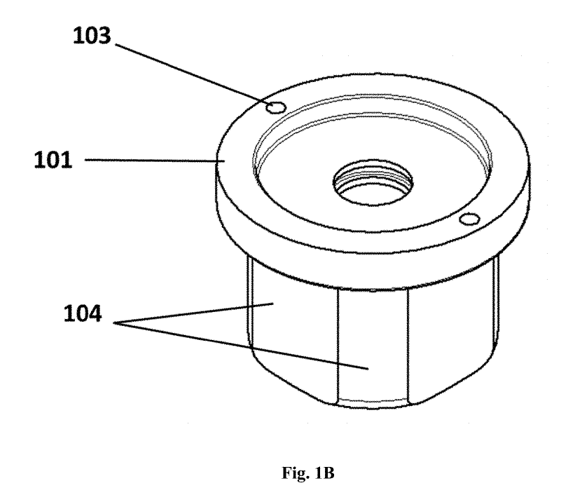

FIG. 1A shows a taper-evidencing collar according to an exemplary embodiment. As shown in FIG. 1A, the collar may be cylindrical in shape, however the collar may take other shapes such as square, rectangular, triangular, hexagonal, or other shapes. The collar of FIG. 1A includes a flange portion 101 that has a larger radius than the body portion 102 below it. The flange portion 101 may include one or more holes 103 for securing the collar to the air pulse unit. The exemplary collar of FIG. 1A includes four holes, however, any number of holes may be used. The collar may be secured to the air pulse unit with non-reversing screws, pop-rivets, or other mechanical fastening mechanism that cannot be removed without leaving evidence that the fastening mechanism was removed. The collar of FIG. 1A shows four screw holes, but any number of screws, pop-rivets, etc. may be used so as to prevent rotation of the collar.

FIG. 1B shows a tamper-evidencing collar according to another exemplary embodiment. The collar of FIG. 1B includes a circular flange portion 101 as in FIG. 1. However, the body portion 102 of the collar shown in FIG. 1B includes multiple facets 104 connected to each other around the circumference of the collar, such that the out surface of body portion 102 is not round. According to an exemplary embodiment, the body portion 102 may include five or six facets, however the exemplary embodiment is not limited thereto and may include any number of facets.

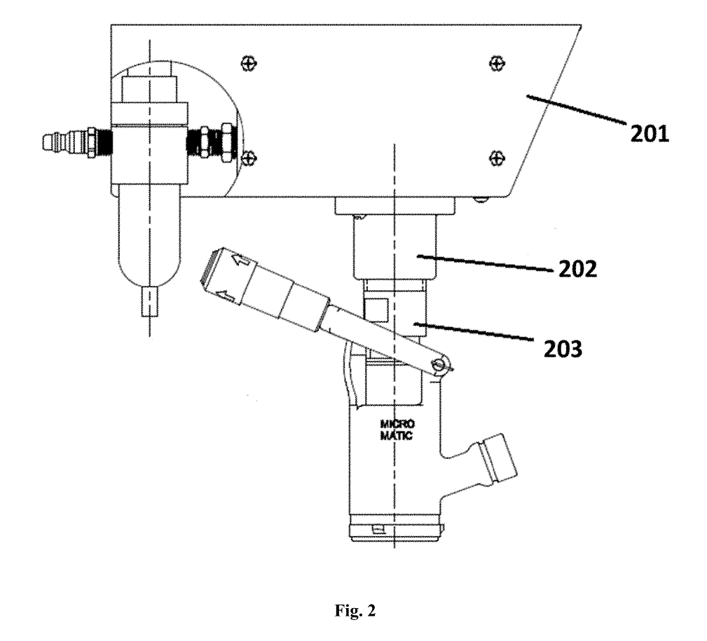

FIG. 2 shows an example of how the collar may be attached to an air pulse unit and a coupler, according to an exemplary embodiment. Collar 202 is coupled to air pulse unit 201, and is also coupled to coupler 203. Coupler 203 is also connected to a container (not shown) that holds the contents to be stirred. The air pulse unit 201 generates an air pulse that travels through collar 202 and coupler 203 to stir the contents of the container attached to coupler 203.

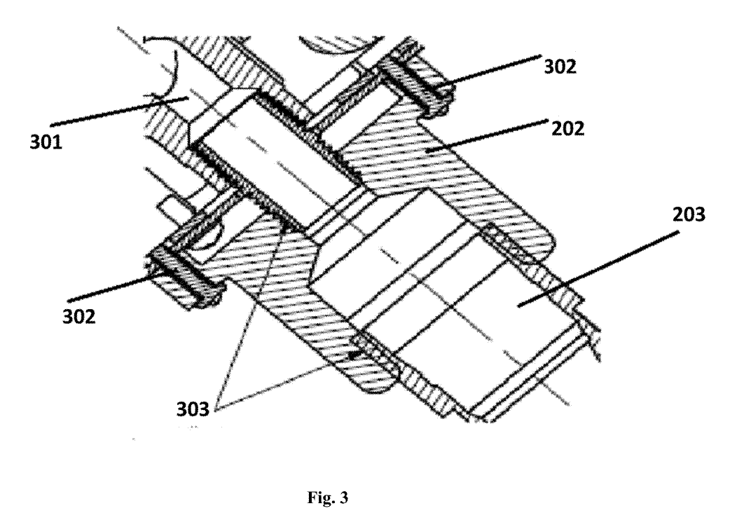

FIG. 3 shows a cross sectional view of coupler 203, collar 202 and air pulse unit 201. Referring to FIG. 3, collar 202 is coupled to coupler 203 using a threaded connection and a permanent adhesive 303 such as Titan 7680 adhesive. In addition, collar 202 is coupled to a connecting nipple 301 of the air pulse unit 201 using a permanent adhesive. Screws 302 are also used to securely couple collar 202 to air pulse unit 201. If one were to attempt to remove the collar 202 from the air pulse unit 201, the screws 302 would break, leaving evidence that the collar has experienced tampering. Thus, the screws 302 allow the collar to be removed for benign purposes, such as maintenance, but provide an indication of any tampering with the collar.

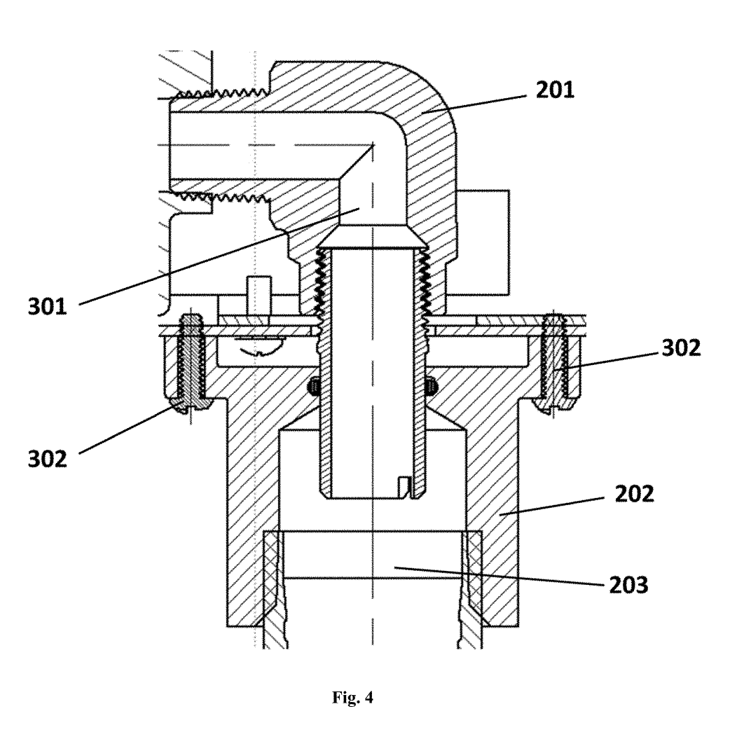

According to another exemplary embodiment, the collar 202 may be secured solely to the air pulse unit 201 with tamper evident fastener 302. As shown in FIG. 4, the collar is attached with two fasteners 302, however any number of fasters may be used, provided the collar 202 is secure to the air pulse unit 201. The collar 202 is also secured to a coupler 203. The collar 202 is secured to the coupler 203 using a threaded connection and a permanent adhesive such as Titan 7680 adhesive. The coupler 203 is also connected to a container (not shown). The collar 202 provides a sliding fit for a connecting nipple of the air pulse unit to allow for typical manufacturing variation within the air pulse unit. The sliding fit illustrated is sealed against low pressure air leaks with an 0-ring; however any number of common air tight fittings may be used.

Although the inventive concepts of the present disclosure have been described and illustrated with respect to exemplary embodiments thereof, it is not limited to the exemplary embodiments disclosed herein and modifications may be made therein without departing from the scope of the inventive concepts.

What is claimed is:

1. A tamper-resistant collar, comprising:
a body portion have a first diameter; and
a flange portion having a second diameter that is greater than the first diameter;
wherein the flange portion includes a plurality of holes configured to receive fasteners that couple the collar to an air pulse generating unit.

2. The tamper-resistant collar of claim 1, wherein the body portion comprises a plurality of facets connected to each other around a circumference of the body portion.

3. The tamper-resistant collar of claim 1, wherein the body portion includes a threaded inner portion configured to securely receive a coupler device.

4. The tamper-resistant collar of claim 3, wherein the threaded inner portion includes a permanent adhesive configured to adhere the collar to the coupler device.

5. The tamper-resistant collar of claim 1, wherein the flange portion includes a hole configured to receive a nipple portion of the air pulse generating unit.

6. The tamper-resistant collar of claim 5, wherein the hole in the flange portion includes a permanent adhesive configured to adhere the nipple portion of the air pulse generating unit to the flange portion of the collar.

7. The tamper-resistant collar of claim 1, wherein the plurality of holes in the flange portion of the collar are configured to break the fasteners if the collar is attempted to be disconnected from the air pulse generating unit.
